(19) United States
(12) Patent Application Publication
(10) Pub. No.: US 2011/0280713 A1
(43) Pub. Date: Nov. 17, 2011

(54) High Volume Pump having low hydrostatic head

(75) Inventor: David M. Baker, Mosinee, WI (US)

(73) Assignee: PDM SOLAR INC., Wausau, WI (US)

(21) Appl. No.: 13/105,830

(22) Filed: May 11, 2011

Related U.S. Application Data
(63) Continuation of application No. 61/333,643, filed on May 11, 2010.

(51) Int. Cl. F01D 11/00; G06F 17/50

(52) U.S. Cl. 415/170.1; 703/1

(57) ABSTRACT

A pump for providing high volume flows with a low hydrostatic head. The pump is particularly suited for heated fluids such as those from a solar collector and the like.

### CROSS REFERENCE TO RELATED APPLICATIONS

This application claims priority from U.S. provisional application No. 61/333,643 filed 11 May 2010; entitled High Volume Pump having low hydrostatic head. The entire contents being hereby included by reference and for which benefit of the priority date is claimed.

### FIELD OF THE INVENTION

The present invention is directed toward a rotary kinetic energy fluid pump having a high volume while maintaining a low hydrostatic head.

### BACKGROUND OF THE INVENTION

In systems similar to those filed in U.S. patent application Ser. No. 11/387,405 entitled “Electrical generation from low temperature thermal energy” and patent application Ser. No. 12/517,421 “Air conditioning by vapor compression and expansion”, there can be a need, depending upon configuration, to move substantially high volumes of fluid through a solar collector efficiently in order to collect solar energy for converting into work. It is anticipated that these systems will be deployed in situations where the system is off the grid. This means that energy required to run the system will need to be generated by the system.

The preferred system will be able to circulate large volumes of water or fluid while consuming a small amount of work energy.

The solar collectors are preferably designed to have large flow channels with a small flow resistance, therefore requiring a low head pressure to create sufficient flow. Further it is desired due to cost constraints and maintainability that the pump circuit be low pressure to minimize hose and joint expansion, use lower grade fittings and materials etc. The walls of the solar collectors may be formed from flat (not curved or tube) polymers. Such collector walls are not designed to withstand much pressure, and don't need to if a low flow resistance is achieved.

In such systems, as the water is heated, the saturation pressure (or fugacity) increases. If the pump produces a vacuum or suction at the inlet of the pump so that the absolute pressure at the inlet is less than the saturation pressure, the pump can go into cavitation. The efficiency of the pump is greatly diminished even to the point that it can stop pumping fluid, which can cause the solar collectors to overheat either locally or systemically. The present application discloses new and innovative pump design to minimize and prevent this cavitation and subsequent overheating.

### SUMMARY OF THE INVENTION

In accordance with the present invention, there is provided in at least one embodiment, a pump providing water flow of between 60-70 gallons per minute through a set of solar panels comprising approximately 900 square foot solar collection surface area using only 50-70 watts to run the pump. These panels, at peak operation, can output typically between 30-40 kWatts of heat energy. Water temperatures up to 185° F. have been pumped in an unpressurized system without concern for cavitation.

It is therefore an object of the invention to provide a high output flow rates with low hydrostatic head.

It is therefore an object of the invention to pump high temperature water at low pressures without cavitation.

It is another object of the invention to pump fluids with little input energy.

It is another objective of the invention to have a pump which has low capital and operating costs.

It is another objective of the invention to provide a pump which protects the solar collectors from overheating.

### BRIEF DESCRIPTION OF THE DRAWINGS

A complete understanding of the present invention may be obtained by reference to the accompanying drawings, when considered in conjunction with the subsequent, detailed description, in which:

FIG. 1 shows a schematic view of a version of a heat pump and heat engine embodiment requiring a pump of the present invention;

FIG. 2 shows a schematic view detailing the heat exchanger portion of the heat engine from the embodiment shown in FIG. 1;

FIG. 3 shows a schematic view detailing the heat exchanger portion of the heat pump from the embodiment shown in FIG. 1;

FIG. 4A shows a top perspective view of an input portion of an embodiment of a pump impeller of the present invention;

FIG. 4B shows a through view of a side of an embodiment of a pump impeller of the present invention;

FIG. 4C shows a bottom perspective view of an output portion of an embodiment of a pump impeller of the present invention;

FIG. 5A shows a perspective view from the center for an (nth) section of the impeller shown in FIG. 4;

FIG. 5B shows a perspective view of the (nth) section of 5A rotated approximately 45 degrees clockwise;

FIG. 5C shows a perspective view of the (nth) section of 5A rotated approximately 60 degrees counterclockwise;

FIG. 5D shows a partially through orthogonal view of the face of 5B;

FIG. 5E shows a partially through orthogonal view of the face of 5C;

FIG. 6 in general shows the combination of two sections (n) (n−1) from FIG. 5 which illustrates the interdigitated nature of the sections spanning (n) (n−1) (n−2) and (n−3) channels and focusing primarily on input characteristics;

6A-6C and 6E contains two sections joined (n) and (n−1) and shows a top right, bottom right, face on and back on view(s) of the sections;

FIGS. 6D and 6F shows through views of the (n) and (n−1) sections;

FIG. 7 focuses mostly on the outlet characteristics of a section;

FIGS. 7A-7B shows a perspective top view of an outlet;

FIG. 7 D shows a perspective bottom view of an outlet;

FIG. 7C, shows a partial through perspective view of an outlet;

FIG. 7E shows a partial through orthogonal view of an outlet;

FIG. 7F shows a through perspective view of an outlet;

FIG. 8 shows a schematic representation of the inflection point of the impeller of the pump between acceleration/compression and deceleration/expansion with pressure conversion.

### DETAILED DESCRIPTION

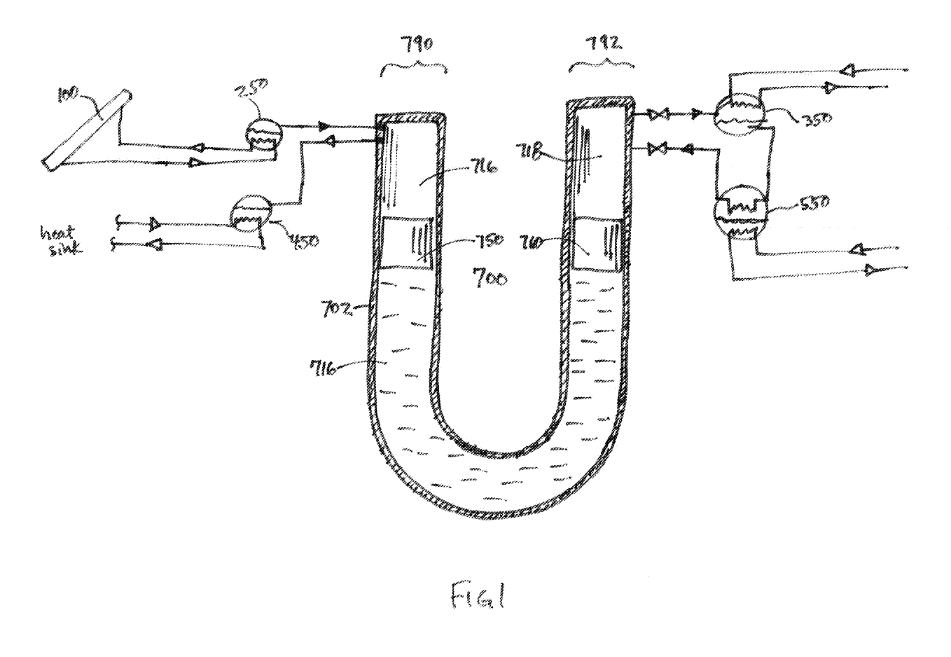

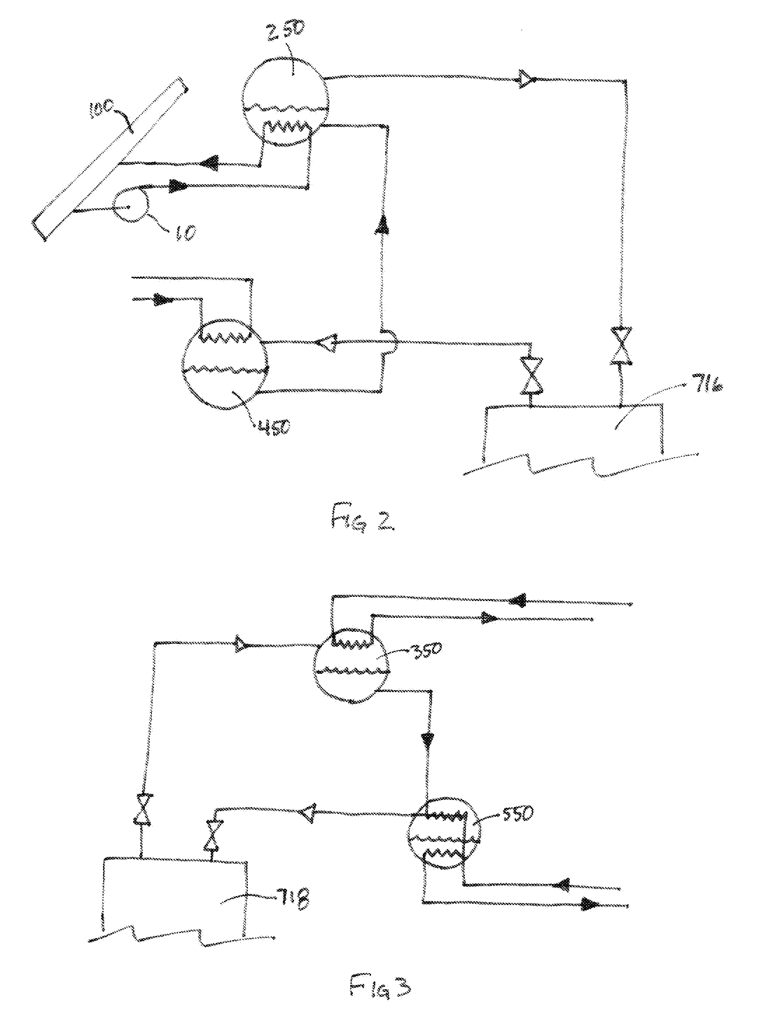

A system which incorporates aspects of a pump of the current design is shown in FIG. 1. A solar collector (100) for such a system would preferably be designed such that a pump (10) for providing large volume of fluid flow across a heat exchanger (250) of the heat engine evaporator would be advantageous in order to act as a nearly constant temperature heat source into the heat engine chamber (716). Various heat exchangers may be deployed (250) (350) (450) (550), as shown in FIGS. 2 and 3, in order to further segregate various fluids to the various working channels of the HE and HP in order to maximize properties of each.

Care should be taken to keep the vapor pressure of the liquid connecting rod (LCR) fluid from exceeding the total pressure of the working fluid, resulting in a possible rapid transfer of heat and mass (vapor of the LCR fluid) from the LCR fluid to the working chamber as a result of boiling of the LCR fluid. If the LCR fluid is physically separated from the working chamber, the higher pressure of the LCR fluid vapor can cause separation or dislocation of the physical separation means from the LCR liquid fluid. This may have the potential to damage the physical separation means and/or interfere with the proper operation of the cycle by reducing the volume of the chamber. Therefore the heat source, heat sink, and ambient temperatures under consideration, should be kept even and controlled so as not to become an issue.

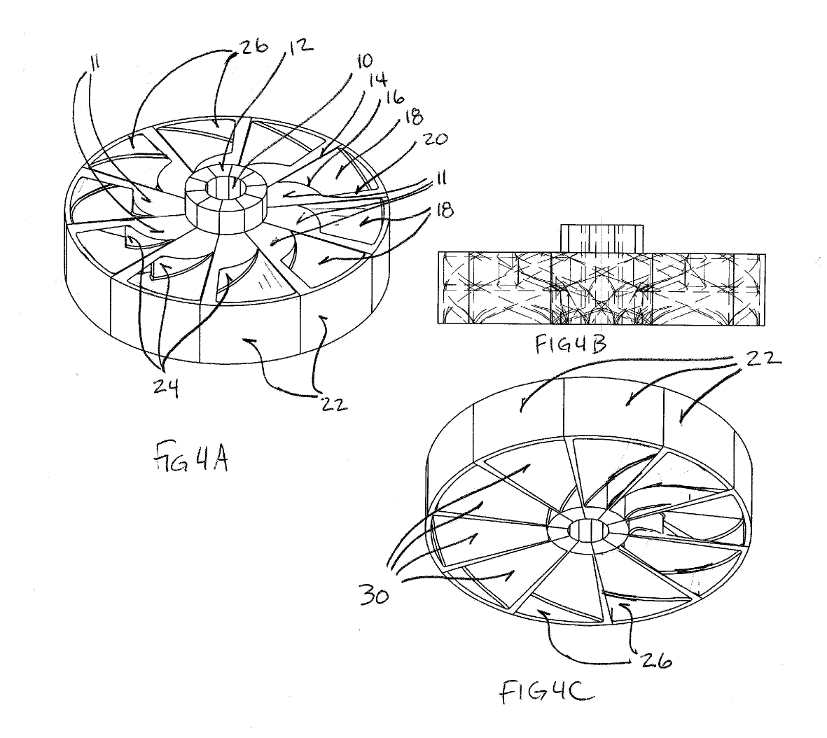

FIGS. 4A-4C show a pump rotor (10) having a hub (12) for rotating on a spindle, in the case of 4A, in a counter clockwise rotation. This embodiment is designed to have a high inlet or throat area (14) relative to the area of the feed pipe (not shown). As the rotor (10) turns, the inlet face (11) spins about an axis or hub (12) imparting momentum onto the fluid in the same direction as the rotation of the inlet face (11). Thus the fluid flowing in the feed pipe continues to flow into the rotor inlet with minimal disruption. While the impeller will operate over a range of rotational velocity it is preferred that the inlet face (11) move at approximately two times the rotational velocity of the adjacent fluid at the inlet face. Under these conditions, a relatively low amount of suction is produced because of the large inlet throat area and gentle slope of the receding face (18). As the fluid is drawn into the throat area it eventually meets a guiding face (30) which can also be seen as the opposing surface to the receding face (18), which along with the shroud (26) and the compressing face (24) form a channel through-which the fluid flows. As the fluid is accelerated by kinetic energy, which by application of the Bernoulli's principle results in an overall decrease in localized pressure, the compressing face (24) following the general direction of acceleration acts to reduce the cross sectional area of the flow channel which slightly increases pressure on the otherwise incompressible fluid roughly in balance with the Bernoulli's equation for decrease in pressure, thus resulting in a minimization of cavitation.

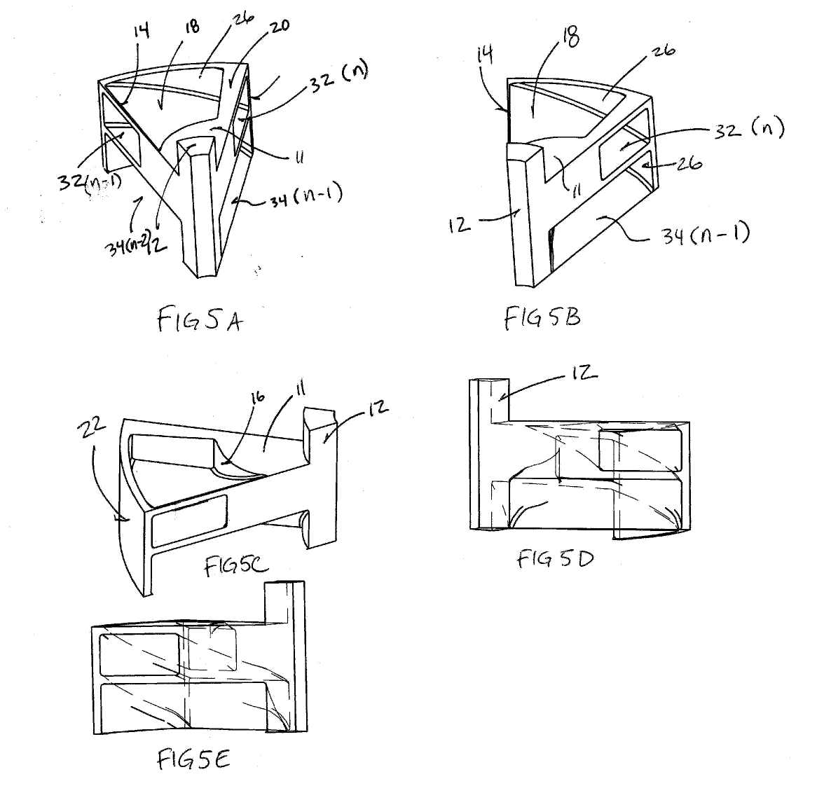

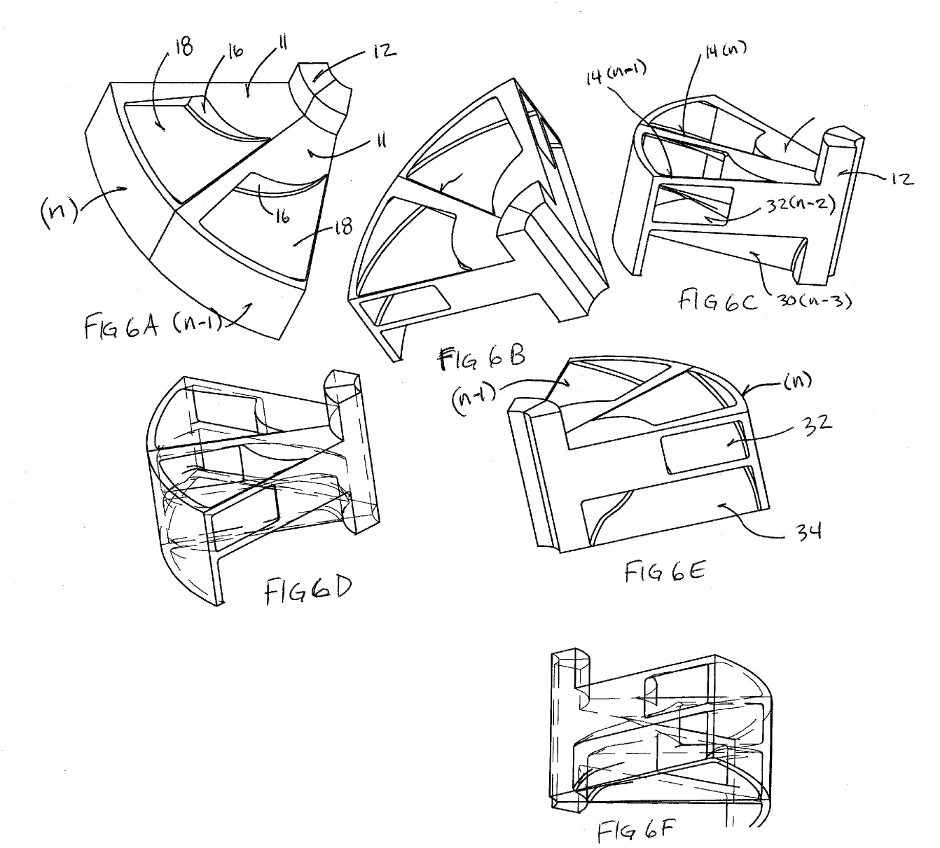

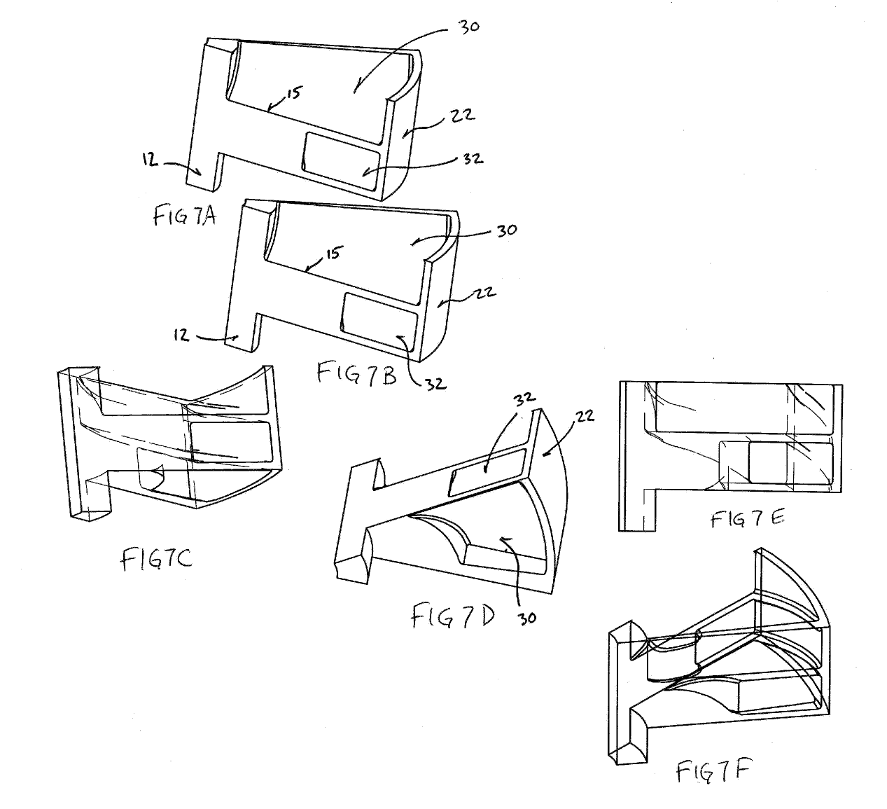

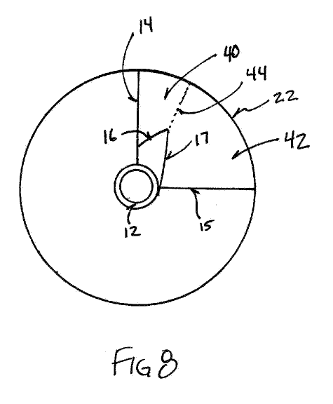

FIGS. 5 through 6 show an (n), (n−1), and (n−2) section(s) depending upon the view which highlight the actual flow through the channels which are nested or interdigitated one with another. Using the throat edge (14) as a reference, the fluid is accelerated and flows along the receding face (18) of the channel while the cross sectional area is minimized at the minimal port area (32) which then flows under the (n+1) section and expands until flowing to the output port (34).

As an alternative way of illustration shown in FIG. 8, the fluid starts in an acceleration zone (40) where the fluid is accelerated by addition of kinetic energy due to the rotation of the throat edge (14) and compressing face (16) in a counterclockwise direction. A portion of the fluid is then scooped between the throat edge (14) and the trailing edge (20) and the compression face (24) and shroud (22) of the input where it flows toward an inflection point (44) where it continues to be accelerated and slightly compressed as the cross sectional volume decreases due to the compression face. The fluid reaches an inflection point (44) where the face recedes and becomes an expansion face (17) and to a deceleration zone (42) where the fluid is decelerated and the kinetic energy previously imparted to the fluid is converted to pressure. The zones (40) and (42) and compression face (16) and expansion face (17) in drawing 8 were exaggerated for teaching. The principles controlling actual acceleration and deceleration for minimization of cavitation are discussed below.

In another way of viewing the current system, as each channel passes by a point in space, a section of liquid is “scooped” off and the liquid continues to flow into the next channel. This is a simplification since the fluid is swirling in the feed pipe above the rotor inlet. The net effect is the differential between the “Bernoulli velocity” as denoted in the table below which measures an angular velocity of the fluid, and the “Outer Port Rotor Velocity” integrated with the “Inner Port Rotor Velocity” which provides, for example, an Outer Relative Velocity”. For example, if the Bernoulli velocity of the fluid is 68 inches per second, and the Outer Port of the Rotor is traveling at 182 inches per second; the Outer Relative Velocity becomes; (182−68=114 inches per second) which provides an understanding of the rate at which fluid at the inlet is “scooped” off to flow through the channel. While somewhat empirical, this model has provided predictable results when matched with mechanical measurements.

Relative to a fixed point, the fluid in each rotor channel is accelerated in the direction from the entrance of the channel to the outlet of the channel opposite the direction of the pressure or head development across the pump because the exit pressure is higher than the inlet pressure. However the fluid flow velocity component along the channel flow path at the channel inlet is designed to be approximately 37% of the velocity of the rotor channel. Thus relative to the rotor, the fluid flows through the rotor channel from the inlet of the channel to the exit of the channel, causing flow from the lower pressure inlet to the higher pressure outlet.

Since the fluid in the free stream in the feed pipe has little to no component of velocity in the direction of the rotor rotational velocity (only along the axial direction of the tube), the action of the rotor causes the fluid flow velocity to increase in the direction from the exit of the channel to the inlet of the channel. This adds energy to the fluid. As the fluid passes through the rotor channel, the area of the rotor channel increases and thus the velocity of the fluid decreases, converting the flow energy into pressure per Bernoulli's equation. In the preferred embodiment, the decrease in the rotor channel area is designed to provide a constant deceleration rate of the fluid as it flows through the channel.

This embodiment currently does not use a seal at the outer diameter of the rotor. The radial clearance is set for an acceptable flow loss between the outer diameter of the rotor and the inner diameter of the pump housing.

### Preferred Embodiment

Design perimeters for one embodiment of the present invention can be shown in the table below:

Design Parameter

| Element | Value | Unit |
|---|---|---|
| Housing OD | 5.5 | inch |
| Housing Wall | 0.24 | inch |
| Pipe ID | 5.02 | inch |
| Pipe Area, Inside | 19.79 | in\hat{ }2 |
| Desired Clearance Radial | 0.01 | inch |
| Shroud OD | 5.00 | inch |
| Design Flow Rate | 70 | gpm |
| Number of Ports | 10 | ports |
| Design Rotor Speed | 720 | rpm |
| Design Differential Pressure | 6 | inch water |
| Bernoulli velocity | 68.03 | in/sec |
| Average Axial Flow | 13.62 | in/sec |
| Specific gravity | 1 | (water) |
| Port Outer Radius | 0.085 | inch |
| Port Width | 0.85 | inch |
| Port Inner Radius | 1.5650 | inch |
| Port Height | 0.4 | inch |
| Port Area | 0.34000 | in\hat{ }2 |
| Section Thickness | 0.48 | in |
| Outer Port Rotor Velocity | 182 | in/sec |
| Inner Port Rotor Velocity | 118 | in/sec |
| Outer Relative Velocity | 114 | in/sec |
| Inner Relative Velocity | 50 | in/sec |
| Flow Rate per Port | 27.9 | in\hat{ }3/sec |
| Outer Port Chord Length | 1.52 | in |
| Inner Port Chord Length | 0.98 | in |
| Port to Port Time | 0.0083 | seconds |
| Axial Flow, Per Port | 51.01 | in\hat{ }3/sec |
| Minimum Hub Diameter | 1.25 | in |
| Max Port Width | 1.79 | in |

This embodiment currently does not use a seal at the outer diameter of the rotor. The radial clearance as defined above is set for an acceptable flow loss between the outer diameter of the shroud and the inner diameter of the pump housing.

### CONCLUSION, RAMIFICATIONS, AND SCOPE

Although the present invention has been described in detail, those skilled in the art will understand that various changes, substitutions, and alterations herein may be made without departing from the spirit and scope of the invention in its broadest form. The invention is not considered limited to the example chosen for purposes of disclosure, and covers all changes and modifications which do not constitute departures from the true spirit and scope of this invention.

For example, although the foregoing refers to applications for high flow, low head flows used in solar energy collection, it is contemplated that the present invention could be used for other high flow applications.

Further, compressor face and channel details may vary from application to application in terms of dimensions and number and position of structural members.

In other embodiments there may be differing ratios of throat opening to constriction values at the inflection point.

Having thus described the invention, what is desired to be protected by Letters Patent is presented in the subsequent appended claims.

We claim:

1. An axial pump for moving large fluid flows with a small hydrostatic head comprising:
(i) a pipe containing fluid leading to and from a housing;
(ii) a plurality of sections working in concert, each section comprising an inlet and an outlet for moving fluid and a compression face;
(iii) the sections rotating about an axis parallel to the direction of the pipe;
(iv) each of the inlets having a channel for receiving the moving fluid;
(v) the compressing face working in cooperation with said channel for adding a constriction in the cross sectional area of the fluid as the fluid accelerates through the channel;
(vi) a transition region wherein the fluid decelerates smoothly transforming the movement of the fluid into hydrostatic pressure as the cross sectional area of the channel increases.

2. An axial pump for moving large fluid flows with a small hydrostatic head in accordance with claim 1 wherein the channel further comprises an inlet throat, a guiding face, and a receding face.

3. An axial pump for moving large fluid flows with a small hydrostatic head in accordance with claim 2 wherein the channel further comprises a shroud.

4. An axial pump for moving large fluid flows with a small hydrostatic head in accordance with claim 3 wherein the clearance between the outer diameter of the shroud and the inner diameter of the housing is approximately two one hundredths of an inch.

5. An axial pump for moving large fluid flows with a small hydrostatic head in accordance with claim 4 further comprising a seal between the shroud and the housing.

6. An axial pump for moving large fluid flows with a small hydrostatic head in accordance with claim 4 wherein each of the compressing faces further imparts momentum to the fluid preceding each of the inlets in the same direction as the rotation of the inlet face.

7. An axial pump for moving large fluid flows with a small hydrostatic head in accordance with claim 6 wherein the rotational velocity of the plurality of sections is approximately twice that of the angular velocity of the adjacent fluid at the inlet.

8. An axial pump for moving large fluid flows with a small hydrostatic head in accordance with claim 7 wherein the fluid is water.

9. An axial pump for moving large fluid flows with a small hydrostatic head in accordance with claim 8 wherein the water is near the boiling point.

10. A method for designing an axial impeller type pump for moving large volumes of fluid at a low hydrostatic head comprising:
(i) providing an acceleration zone wherein a fluid is rotationally accelerated before an inlet to a pump;
(ii) scooping a portion of the fluid between a throat edge and a trailing edge of an inlet, the area being further bounded by a shroud and a compression face,
(iii) compressing the fluid by means of a compression face as the fluid accelerates;
(iv) providing an inflection point where the compression face recedes to expand the cross sectional area whereby the fluid decelerates and the kinetic energy previously imparted to the fluid is converted to pressure.
